(19) United States
(12) Patent Application Publication
(10) Pub. No.: US 2013/0092250 A1
(43) Pub. Date: Apr. 18, 2013

(54) Valve Assembly with Adjustable Spring Preload and Tool Kit for Adjusting the Spring Preload

(71) Applicants: Christian Spielvogel, Eutingen (DE); Martin Zug, Hirrlingen (DE)

(72) Inventors: Christian Spielvogel, Eutingen (DE); Martin Zug, Hirrlingen (DE)

(73) Assignee: Robert Bosch GmbH, Stuttgart (DE)

(21) Appl. No.: 13/520,122

(22) PCT Filed: Nov. 19, 2010
(86) PCT No.: PCT/EP2010/007036

§ 371 Date: Dec. 10, 2012

(30) Foreign Application Priority Data
Dec. 30, 2009 (DE) 10 2009 060 755.2

(51) Int. Cl. F16K 13/00

(52) U.S. Cl. CPC F16K 13/00
USPC 137/315.27

(57) ABSTRACT

A control valve assembly includes a valve body which is pre-stressed in a direction by a control spring assembly. The spring preload of the control spring assembly is adjustable by an adjusting device which is completely accommodated in the valve box or a fitted housing part.

The present invention relates to a valve assembly, in particular a control valve of a variable displacement pump, according to the preamble of patent claim 1 and to a tool kit for adjusting the spring preload of a valve assembly of this type.

DE 101 36 416 A1 has disclosed a control valve assembly of the generic type. It has a valve housing, into which a pressure control valve and a delivery flow control valve are integrated. A control piston of the control valves is prestressed in one direction in each case by means of a control spring. In the known solution, a spring housing is attached to the valve housing on the end side, in which spring housing the respective control spring is arranged which acts on the control piston via a spring collar. Said control spring is supported for its part on a supporting disk which can be adjusted in the axial direction by means of a setting screw, with the result that the control spring preload can be adjusted via the setting screw.

Control valves of this type for variable displacement pumps are usually set to values which are requested by the customer. This setting operation is preferably performed only a single time at the pump manufacturer before the variable displacement pump is shipped. For this purpose, the variable displacement pumps are set by a testing person on test benches during the pump manufacturing and are secured against subsequent, accidental changing of the setting. In the control valves of the generic type, for example, this securing takes place via a lock nut, via which the setting screw is locked to the spring housing. In order to seal the spring space, O-rings are also required in the known solution, which O-rings firstly seal the overlapping region between the spring housing and the valve housing and secondly seal the region between the setting screw and the spring housing, with the result that the spring space which accommodates the control spring is closed reliably to the outside. After the adjustment, the setting screws are protected by means of securing caps which are attached to the spring housing.

It is a disadvantage of this solution that a multiplicity of components have to be provided for adjusting and supporting the control spring and a multiplicity of seals have to be provided for sealing the spring space.

In contrast, the invention is based on the object of providing a valve assembly of simple construction and a tool kit for adjustment.

This object is achieved by a valve assembly having the features of patent claim 1 and a tool kit in accordance with claim 9.

Advantageous refinements of the invention are the subject matter of the subclaims.

According to the invention, the hydraulic valve assembly is configured with a valve housing, in which a valve bore which accommodates a valve piston is formed. Said valve piston is prestressed via one or more springs, the preload of which can be adjusted via a setting device. Said setting device has a screw element which can be adjusted in order to change the spring preload and the desired position of which is fixed via a securing means. According to the invention, the screw element and the securing means are screwed into a common threaded hole and are thus covered to the outside and are therefore not readily accessible.

The concept according to the invention digresses from the conventional solutions, in which a setting screw protrudes and is locked against the housing by means of a lock nut which is screwed onto the setting screw. Although, as mentioned above, said setting screws are protected against accidental adjustment via securing caps, the latter can be removed very simply or else be lost, with the result that there is firstly a risk of damage to the protruding setting screws and secondly unauthorized adjustment of the spring preload is possible. In the solution according to the invention, both the setting screw and the securing means are received completely in a common threaded hole and can therefore be covered reliably to the outside in a simple way, with the result that, even if the cover is lost, at least no damage to said setting elements is to be feared.

In one particularly preferred exemplary embodiment, the threaded hole for the screw element and the securing means is not formed, as in conventional solutions, in a spring housing which is attached to the valve housing, but rather is provided directly as an extension of the threaded hole in the valve housing, with the result that the construction of the valve is simplified considerably with respect to known solutions, some sealing points (outer circumference of the spring housing, inner circumference of the spring housing) also being omitted and therefore both the manufacturing and the assembly being simplified.

In one exemplary embodiment of particularly simple construction, the screw element is configured as a threaded pin and the securing means is configured as a lock nut which is formed with a passage for the screw element. That is to say, the screw element can be adjusted through the lock nut via said passage.

Simple adjustment is ensured if the threaded pin is configured with a polygon socket, and the lock nut has a passage hole having at least the external diameter of the polygon, with the result that a corresponding polygonal key can be applied to the threaded pin through the lock nut.

In order to avoid unauthorized adjustment of the spring preload, a securing cap can be provided which is placed onto the lock nut after the adjustment.

The securing action is particularly effective if the securing cap can be released only by destruction or deformation.

In order to prevent the setting device being screwed accidentally out of the threaded hole, a securing ring or the like can be inserted into the rearward end section of the threaded hole.

The hydraulic valve assembly according to the invention having the special setting device described can preferably be used in a control valve for a variable displacement pump, it being possible for the setting device to be assigned in each case to a delivery flow control valve and/or a pressure control valve.

Another part of the invention is a tool kit for adjusting the spring preload, having a tool, on which a polygon is formed at one end section and which is configured with a passage hole, through which a further tool can be applied.

In the above-described valve assembly, the screw element and the securing means can be adjusted at the same time by way of a tool kit of this type, without a tool change.

In the following text, one preferred exemplary embodiment of the invention will be explained in greater detail using diagrammatic drawings, in which:

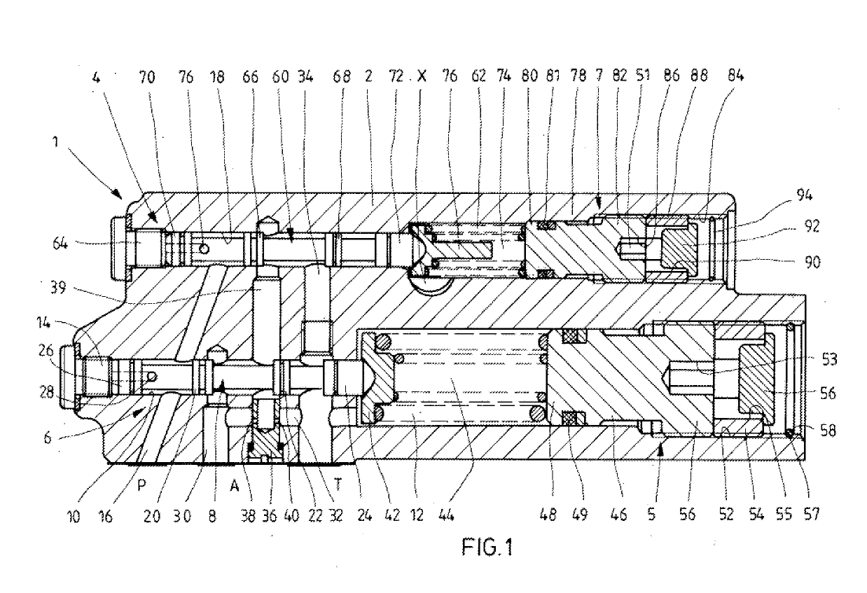

FIG. 1 shows a longitudinal section through a control valve assembly of a pump controller,

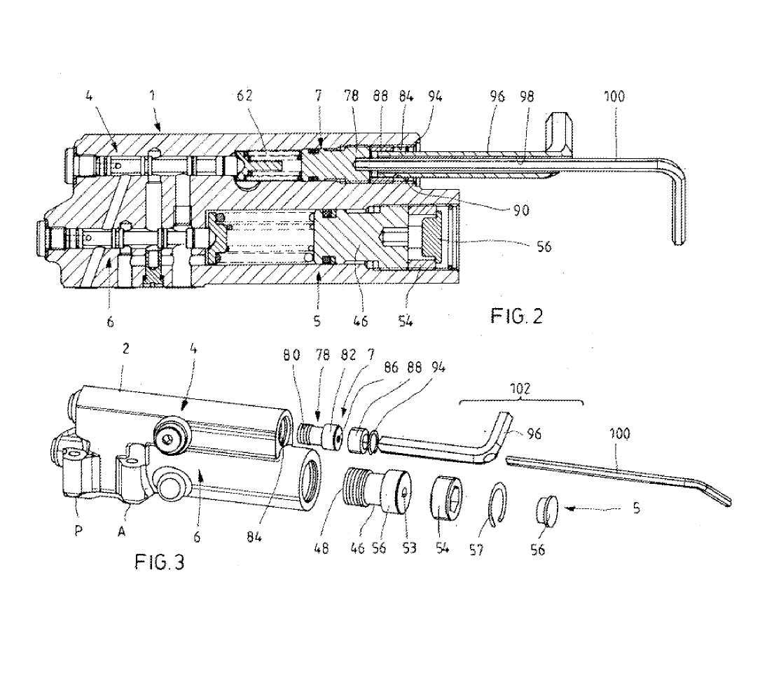

FIG. 2 shows the longitudinal section from FIG. 1 with an applied tool kit, and

FIG. 3 shows a 3D exploded illustration of the arrangement from FIG. 2.

The basic construction of said control valve assembly 1 is described in detail in the prior art described in the introduction according to DE 101 36 416 A1. Furthermore, the diagrammatic construction of the pump controller is explained in the data sheet RD 92 711/10.07 issued by Bosch Rexroth AG, with the result that, in the following text, only the components which are essential to understand the invention are described and otherwise, for the sake of clarity, reference is made to the abovementioned prior art.

The control valve assembly 1 shown in FIG. 1 has a valve housing 2, in which a delivery flow control valve 4 and a pressure control valve 6 are accommodated. The pressure control valve 6 brings about a stabilization of the pressure in a hydraulic system within the control range of the pump. By means of the delivery flow control valve 4, the delivery flow of the pump can be set via a differential pressure at the consumer, with the result that the pump delivers only the pressure medium quantity which is actually required by the consumer.

A pressure connection P which conducts the pump pressure, a working connection A, a tank connection T and an LS connection X (merely indicated in the figure) are provided on the valve housing. Said working connection A has a pressure medium connection to a pressure space of an actuating cylinder, via which, as explained on the data sheet RD 92 711, a pivoting angle of an adjustable axial piston pump can be adjusted. A swash plate of said axial piston pump is swiveled out via a spring mechanism and can be swiveled back by the pressure in the pressure space of the actuating cylinder. The highest charge pressure of all the consumers of the system which is supplied with pressure medium via the pump prevails at the LS connection X, which charge pressure is tapped off from the consumers, for example, via a two-way valve cascade.

The pressure control valve 6 has a pressure control piston 8 which is guided in a valve bore 10 and is prestressed via a pressure control spring assembly 12 with two springs arranged coaxially with respect to one another into the basic position shown, in which it bears against a screw plug 14 which is inserted into the valve bore 10. A pressure channel 16 which leads to the pressure connection P, is configured as an oblique hole and extends beyond the valve bore 10 to a valve bore 18 of the delivery flow control valve 4 opens into the valve bore 10. The pressure control piston 8 is configured with a control collar 20, a guide collar 22 which is arranged adjacently thereto, and two end collars 24 and 26. In the basic position, the left-hand end collar 26 in the figure bears against the screw plug 14 and, with the latter, delimits a control space which cannot be seen in the figure and is loaded via a control hole 28 which is configured as an offset hole with the pressure in the annular space between the end collar 26 and the control collar 20. This control pressure corresponds to the pump pressure.

A working channel 30 which is likewise configured as a blind bore opens into the working connection A which is connected hydraulically to the actuating cylinder, which working channel 30 intersects the valve bore 10 and into which working channel 30, in the basic position which is shown, the control collar 20 dips with its right-hand end section, with the result that the pressure medium connection between the pressure connection P and the working connection A is shut off.

In FIG. 1, a longitudinal channel 32 runs below the valve bore 10 parallel to the latter, which longitudinal channel 32 opens on the right into a tank channel 34 which leads to the tank connection T. A nozzle body 36 with two radial nozzles 38, 40 is inserted into said longitudinal channel 32 in the transverse direction, via which radial nozzles 38, 40 the working channel 30 is connected to the tank channel 34. An intermediate channel 39 opens between said two nozzles 38, 40, which intermediate channel 39 connects the two valve bores 10, 18 to one another and into which intermediate channel 39, in the basic position which is shown, a left-hand end section of the guide collar 22 dips, with the result that, in said basic position, the pressure medium connection between the working channel 30 and the connecting channel 39 is opened in a controlled manner by the control groove between the two collars 20, 22.

The right-hand end collar 24 in FIG. 1 bears against a spring collar 42, on which the pressure control spring assembly 12 acts. The spring collar 42 is arranged in a spring space 44 which is configured as a radially widened portion of the valve bore 10. In contrast to the prior art which was described in the introduction, said spring space 44 is formed exclusively in the valve housing 2 and not in a dedicated spring housing. The control pressure of the delivery flow control valve 4 and the pressure control valve 6 can be set in each case via an associated setting device 5 and 7. The construction of said setting devices 5, 7 will be described in greater detail in the following text.

The control spring assembly 12 is supported on a threaded pin 46, the left-hand end section 48 in FIG. 1 of which dips into the spring space 44 and the right-hand end section of which is configured as a threaded piece 50 which is widened somewhat in the radial direction in comparison with the end section 48 and is separated from the latter via a circumferential groove 51. The threaded piece 50 is in threaded engagement with a threaded hole 52 which is correspondingly widened in the radial direction in comparison with the diameter of the spring housing 44. A hexagon socket 53 is formed in the threaded piece 50 on the end side for attaching a tool which is described in the following text. The axial position of the threaded piece 50 and therefore the preload of the control spring assembly 12 are fixed positionally via a lock nut 54 which is likewise screwed into the threaded hole 52 and is locked with the threaded pin 46 after the adjustment of the spring preload. The lock nut 54 is likewise configured with a hexagon socket 55, the diameter of which is substantially larger than that of the hexagon socket 53 of the threaded piece 50. According to FIG. 1, said hexagon socket 55 penetrates the entire lock nut 54 in the axial direction, with the result that the tool for adjusting the threaded pin 46 can be applied through the lock nut 54. An annular groove for accommodating a seal arrangement 49 is provided on the outer circumference of the end section 48.

After adjusting and locking have been carried out, a securing cap 56 is placed onto the lock nut 54. Said securing cap 56 is preferably configured with an interference fit, with the result that a release is possible only with destruction of the securing cap 56. Instead of the interference fit, the securing cap 56 can also be connected to the lock nut 54 by adhesive bonding, welding or the like. According to the invention, provision is made to produce the securing cap 56 from a plastic.

In order to avoid the setting device 5 being screwed out of the threaded hole 52 unintentionally, a securing ring 57 which engages, for example, into an annular groove 58 is inserted into the threaded hole 52 at an axial spacing from the securing cap 56.

The delivery flow control valve 4 which is shown at the top in the figure has a control piston 60 which can be displaced in the valve bore 18 and, in the basic position according to the figure, is prestressed via a control valve assembly 62 against a further screw plug 64. The control piston 60 has a control collar 66, a guide collar 68 and two end collars 70, 72. The last-mentioned end collar 72 dips into a spring space 74 for the control spring assembly 62 and, in the basic position, the other end collar 70 bears against the screw plug 64 and, with it, delimits a control space which is loaded via a further control hole 76 which is configured as an offset hole with the pressure in an annular space between the control collar 66 and the end collar 70. The pressure channel 16 opens into said annular space, with the result that the pump pressure prevails in the left-hand control space of the delivery flow control valve 4.

The highest charge pressure of the actuated consumers which is tapped off via the LS connection X acts in the region of the spring space 74 between the adjusting device 7 and the end collar 72. Accordingly, the control piston 60 of the delivery flow control valve 4 is loaded on one side by the pump pressure and on the other side by the charge pressure and by the force of the control spring assembly 62, with the result that, in the control position, the pump pressure is regulated to a pressure which lies above the highest charge pressure by the pressure equivalent of the control spring assembly 62. In this control position, the control collar 66 is situated in congruence with the intermediate channel 39, with the result that, depending on the pressure difference change at a meter-in variable restrictor (not illustrated), the variable displacement pump can be swiveled out (connection to tank pressure) or swiveled back (connection to pump pressure).

The control collar 66 is configured in such a way that, in the basic position, it shuts off the pressure medium connection of said control space and therefore the pressure channel 16 to the intermediate channel 39. In the basic position which is shown, the pressure medium connection between the intermediate channel 39 and the tank channel 34 is opened in a controlled manner via the control groove between the control collar 66 and the guide collar 68, with the result that the working connection A is correspondingly connected to the tank connection T via the working channel 30, the intermediate channel 39 and the tank channel 34, and therefore the pressure space of the actuating cylinder is loaded with tank pressure in order to adjust the pivoting angle (pump swiveled out).

The control spring assembly 62 acts via a spring collar 76 on the end collar 72 of the control piston 60 and is supported on the adjusting device 7, via which in turn the spring preload of the control spring assembly 62 can be set. The basic construction of said setting device 7 corresponds to that of the above-described setting device 5. Accordingly, the control spring assembly 62 is supported on a threaded pin 78 which dips with one end section 80 into the spring space 62 and is screwed with a threaded piece 82 into a threaded hole 84 which is widened radially in comparison with the spring space 74. A hexagon socket 86 for attaching a tool is formed on the threaded piece 82. The positional fixing likewise takes place via a lock nut 88 with a hexagon socket 90 which penetrates the lock nut 88 and through which the tool can be applied in order to adjust the threaded piece 82. The sealing action is brought about via a sealing arrangement 81 which is inserted into a circumferential groove of the threaded piece 82.

In the shipping state, a securing cap 92 is placed onto the lock nut 88. A further axial securing means is formed by a securing ring 94 which is inserted into the threaded hole 84. As described above, there is structural and functional conformity between the setting devices 5, 7, apart from the dimensions—further explanations are therefore unnecessary.

FIG. 2 shows the control valve assembly 1 in a sectional illustration which corresponds to FIG. 1, during the adjustment of the delivery flow control valve, the spring preload of the pressure control valve having already been adjusted and accidental adjustment being prevented by the securing cap 56. The spring preload of the delivery flow control valve 4 is being adjusted in the view according to FIG. 2. The threaded pin 78 is screwed into the threaded hole 84. The lock nut 88 is likewise inserted, but is not yet locked with the threaded pin 78. A hexagon socket key 96 which is configured as a special tool is inserted into the hexagon socket 90 of the lock nut 88, which hexagon socket key 96 is configured with an axial passage channel 98, through which a further conventional hexagon socket key 100 can be applied in order to adjust the threaded pin 78.

The control spring preload is set by adjusting the threaded pin 78 by means of the hexagon socket key 100. As soon as the desired position is reached, the lock nut 88 is tightened via the further hexagon socket key 96 while the hexagon socket key 100 is still attached, and the threaded pin 78 is held firmly in the process, with the result that the desired position cannot change. That is to say, very simple positional fixing of the setting device 7 is possible by way of simultaneous actuation of the two keys 96, 100. After this adjustment, the two keys 96, 100 which form a tool kit 102 (see FIG. 3) are detached and the securing cap 92 is attached in order to prevent unauthorized adjustment. During the adjustment, the securing ring 94 which forms a captive securing means has already been inserted into the threaded hole 84.

FIG. 3 shows the above-described components again, in an exploded illustration. The valve housing 2 with the sections for the delivery flow control valve 4 and the pressure control valve 6 with the connections P, A can be seen, as can the regions which are arranged on the right in FIG. 3 and in which the control spring assembly 62 or the pressure control spring assembly 12 is accommodated. The essential components of the setting devices 5, 7 are shown in an exploded illustration. The two threaded pins 46, 82 can be seen with the end section 48 which dips into the two respective spring spaces 44 and 74, and with the respective threaded piece 56, 82 which is inserted into the threaded hole 52 or 84. Furthermore, the two hexagon sockets 86 and 53, the two lock nuts 54, 88, the securing rings 57, 94 and the securing cap 56 of the pressure control valve 6 can be seen.

The threaded pin 78, the lock nut 88 and the securing ring 94 are inserted into the threaded hole 84, the screwing-in operation taking place in the above-described way via the tool kit 102 with the hexagon socket keys 96 and 100.

One advantage of the embodiment described consists in the fact that the individual actuating elements of the setting devices 5, 7 are accommodated completely in the valve housing 2 and are therefore covered to the outside.

The tool kit 102 is required for the adjustment of the control valve assembly 1, which adjustment is provided by the manufacturer. Without this extra equipment, correct adjustment of the spring preload is possible only with relatively high complexity; accordingly, the necessity of this extra tool kit 102 also contributes to the operating safety.

A control valve assembly is disclosed having a valve body which is prestressed in one direction via a control spring assembly. The spring preload of the control spring assembly can be adjusted via a setting device. The latter is accommodated completely in the valve housing or an attached housing part.

1. A hydraulic valve assembly, comprising:
a valve housing defining a valve bore; and
a valve body configured to be guided in the valve bore,
wherein the valve body is prestressed in one direction by means of at least one spring,
wherein the spring is supported on a setting device with a screw element,
wherein the desired position of the screw element is fixable via a securing means, and
wherein the screw element and the securing means are screwed into a common threaded hole and are covered to the outside.

2. The valve assembly as claimed in claim 1, wherein:
the threaded hole is formed in the valve housing as an extension of the valve bore, and
the screw element dips completely into the associated threaded hole.

3. The valve assembly as claimed in claim 1, wherein:
the screw element is a threaded pin, and
the securing means is a lock nut which is formed with a passage to the threaded pin.

4. The valve assembly as claimed in claim 3, wherein:
the threaded pin defines a polygon socket, and
the lock nut defines a passage recess having at least the external diameter of the polygon.

5. The valve assembly as claimed in claim 3, further comprising:
a securing cap which is placed onto the lock nut.

6. The valve assembly as claimed in claim 5, wherein the securing cap is releasable only after destruction or deformation.

7. The valve assembly as claimed in claim 2, further comprising:
a securing ring which is inserted rearwardly into the threaded hole at an axial spacing from the screw element and from the securing element.

8. The valve assembly as claimed in claim 1, wherein:
the setting device is a first setting device,
said valve assembly is configured with a delivery flow control valve and/or a pressure control valve of a pump controller,
the delivery flow control valve includes a second setting device, and
the pressure control valve of a pump controller includes a third setting device.

9. A tool kit for adjusting the spring preload of a valve assembly, comprising:
a tool which has a polygon at one end section and which has a passage hole for a further tool, which passage hole opens in the region of said polygon,
wherein the valve assembly includes (i) a valve housing defining a valve bore and (ii) a valve body configured to be guided in the valve bore,
wherein the valve body is prestressed in one direction by means of at least one spring
wherein the spring is supported on a setting device with a screw element,
wherein the desired position of the screw element is fixable via a securing means, and
wherein the screw element and the securing means are screwed into a common threaded hole and are covered to the outside.
